(19) United States
(12) Patent Application Publication
(10) Pub. No.: US 2006/0201607 A1
(43) Pub. Date: Sep. 14, 2006

(54) Processing technology for paper-mounted handicrafts

(76) Inventor: Christine Yat Ting Luk, Hong Kong (HK)

Correspondence Address: RABIN & Berdo, PC, 1101 14TH STREET, NW, SUITE 500, WASHINGTON, DC, 20005, US

(21) Appl. No.: 11/218,511

(22) Filed: Sep. 6, 2005

(30) Foreign Application Priority Data
Mar. 10, 2005 (CN) 2005100537008

(51) Int. Cl. B32B 37/12; B32B 37/00; B32B 38/00; B32B 38/10

(52) U.S. Cl. 156/153; 156/219; 156/280; 156/267

(57) ABSTRACT

The present invention discloses a processing technology for figured paper-mounted handicrafts, comprising the steps of: (i) providing a blank, smoothing the blank surface by surface-treatment until it is sufficiently smooth for facilitating adhesive-coating; (ii) coating an adhesive on the blank and mounting a figured-paper on the blank; (iii) soaking the figured-paper mounted blank into an adhesive (or coating an adhesive on the blank), taking it out after a given time period and oven-drying; (iv) then soaking the oven-dried semi-finished product into an Epoxy coating, taking it out and oven-drying again; (v) finally, assembling the oven-dried glue-soaked semi-finished product to obtain a product. By using the processing technology of the present invention, a variety of products having different appearances and higher delicacy can be fabricated.

### FIELD OF THE INVENTION

The present invention relates to a processing technology for handicrafts, more particularly, to a processing technology for paper-mounted handicrafts.

### BACKGROUND OF THE INVENTION

With social development, a wide variety of handicrafts have been put forward to market to meet various interests. However, among currently available handicrafts, paper-mounted handicrafts suffer from small sales volume due to the oversimplified and crude technology, which results in less delicate products and fewer varieties.

By virtue of the inventor's experiences and practice in the related art for many years and investigation and development with great concentration, a processing technology is created, which is simple to operate and capable of fabricating a variety of delicate and well-patterned products.

### DISCLOSURE OF THE INVENTION

The object of the present invention is to provide a processing technology for paper-mounted handicrafts. By using the present technology, handicrafts having various appearances can be fabricated.

The processing technology for paper-mounted handicrafts according to the present invention comprises the steps of:

(i) providing a blank and smoothing the blank surface by surface-treatment until it is sufficiently smooth for facilitate adhesive coating;

(ii) coating an adhesive onto the blank and mounting on the blank a figured-paper;

(iii) soaking the figured-paper mounted blank into an adhesive (or coating an adhesive on the blank), after a given time period, taking the blank out and oven-drying it;

(iv) then soaking the oven-dried semi-finished product into an Epoxy coating, taking it out to treat and then oven-drying it again;

(v) finally, assembling the oven-dried, glue-soaked semi-finished product to obtain a product.

Said step (i) further comprises a step of soaking in a talcum powder, and a step of oil spraying is arranged between step (i) and step (ii).

Said step (i) further comprises a step of powder dusting and a step of glue soaking.

Said step (i) comprises the steps of:

(ia) cutting off by a knife any protruding or excessive parts on the blank and keeping each blank in its integrity;

(ib) abrading off by an abrasive paper any coarse gripper die lines;

(ic) polishing the thus abraded blank to make the blank surface smoother and after the polishing, blowing off any dust on the blank surface.

Said step (ii) comprises the steps of:

(iia) preparing tools and a figured paper and fixing the polished blank on a work-bench;

(iib) coating by a brush a wallpaper powder glue onto the blank evenly;

(iic) aligning a pattern in the figured paper with the corresponding part of the blank and pressing the figured paper onto the blank to cover the corresponding part of the blank with the figured paper.

Said step (iii) comprises the steps of:

(iiia) soaking the figured-paper-mounted blank (a semi-finished product) obtained in step

(ii) in a white glue followed by taking it out and placing it on a work-bench to drip-dry the white glue;

(iiib) then placing the white glue drip-dried semi-product on a rotary tray to allow the white glue flowing and evenly distributing, meanwhile, baking the semi-product in an oven.

Said step (iv) comprises the steps of:

(iva) soaking the oven-dried semi-product (or the white glue coated semi-product) into an Epoxy coating to impart smoothness, transparency, and gloss to the product surface;

(ivb) finally, eliminating any air bubbles in the Epoxy coating on the semi-product surface by using heated-air, preferably at the temperature ranging between 100? C and 150? C, or in vacuum, meanwhile, oven-drying the Epoxy coating to make the product reaching a certain hardness.

Said step of soaking in a talcum powder is such a step, wherein the firstly surface-treated blank is soaked in a talcum powder glue, then is taken out from the talcum powder glue and placed on a rotary tray to air-dry, the air-dried blank is ready for second surface treatment.

Said oil-spraying step is such a step, wherein the surface treated blank is subjected to oil spraying, that is, by using a spraying gun, an oil is evenly sprayed onto the blank, and the oil-sprayed blank is air-dried.

Said powder-dusting step comprises:

(a) prior to final surface treatment, coating a white glue onto the blank;

(b) evenly dusting a glimmer powder onto the white glue-coated blank.

Said glue-soaking step comprises:

(a) soaking the glimmer powder-dusted blank in an Epoxy coating to allow the Epoxy coating evenly covering the blank surface;

(b) eliminating any air bubbles in the Epoxy coating on the blank surface by heated-air, preferably at the temperature ranging between 100? C and 150? C, or in vacuum and oven-drying the blank.

Said glue-coating step is such a step, wherein a white glue is coated by a brush on the figured-paper and its edges of the figured-paper mounted blank to prevent from water stains formation caused by the Epoxy coating penetration underneath the figured-paper in the subsequent step.

By using the processing technology for paper-mounted handicrafts of the present invention, a variety of products having various outer appearances can be fabricated.

### BRIEF DESCRIPTION OF THE DRAWINGS

FIG. 1 is a flow diagram of the processing technology for paper-mounted handicrafts according to the present invention;

FIG. 2 is a flow diagram of the processing technology for powder-dusted paper-mounted handicrafts according to the present invention;

FIG. 3 is a flow diagram of the processing technology for oil-sprayed paper-mounted handicrafts according to the present invention.

### DETAILED DESCRIPTION OF THE INVENTION

The examples of the present invention will be described in details in conjunction with the accompanying drawings as follows.

### EXAMPLE 1

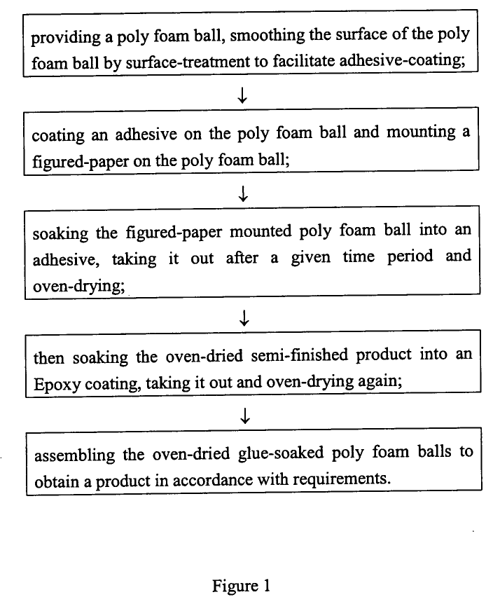

As shown in FIG. 1, in this example a poly foam ball is used as the blank to fabricate a paper-mounted handicraft. The particular technology comprises the following steps:

(i) providing a poly foam ball, smoothing the surface of the poly foam ball by a surface treatment so as to facilitate glue coating for ensuring a surface smoothness; wherein the surface treatment of the poly foam ball comprises the following steps:

(ia) cutting a water mouth on the poly foam ball by using a knife, because each poly foam ball has a water mouth after it is produced, upon using the poly foam ball, the water mouth must be cut so as to reach a smoothness to facilitate the glue coating;

(ib) abrading the coarse gripper die line on the poly foam ball by an abrasive paper to make the surface of the poly foam ball smooth;

(ic) pouring the abraded poly foam balls into a roller for polishing to make the surface of the poly foam ball even smoother to facilitate the subsequent paper mounting process;

(id) after polishing, blowing away any dust on the surface of the poly foam balls.

(ii) coating adhensive on the poly foam ball and then mounting figured-paper onto the poly foam ball, during its operation, this step comprises the following steps:

(iia) fixing the polished poly foam ball onto a fitting pin on a work-bench to make the poly foam ball being freely rotatable, meanwhile, preparing tools and figured-paper and coating the figured-paper with a glue;

(iib) rotating the poly foam ball on the fitting pin, coating evenly a wallpaper powder glue by a brush on the poly foam ball, because the wallpaper powder glue is strongly tacky, after it is evenly coated on the poly foam ball, the figured-paper can be firmly adhered on the poly foam ball during the paper-mounting process;

(iic) overlapping (aligning) the mid-line of the figured-paper with the mid-line of the poly foam ball to make the pattern more integral without inclining;

(iid) after aligning the mid-lines, brushing by a brush the figured-paper clock-wise and firmly pressing the mid-line, the operation of figured-paper pressing starts from the mid-line to prevent the figured-paper from wrinkling;

(iie) following the mid-line pressing, uniformly attaching the upper pattern and the lower pattern piece by piece; rotating the poly foam ball by one hand; pressing by the other hand the figured-paper onto the poly foam ball piece by piece; for mounting paper on the ball, each figured-paper must be cut at its both ends in pieces; for uniformly attaching the pattern lines and maintaining the pattern integrity, the patterns must be moved piece by piece so as to prevent the figured-paper from moving and wrinkling;

(iif) following firmly pressing the figured-paper, removing the poly foam ball, mounting a top cap at the top site of the ball and mounting a bottom cap at the bottom site of the ball, some marks can be designed on the bottom cap.

(iii) soaking the figured-paper mounted poly foam balls into an adhesive and taking them out after a given time period and oven-drying (this step can be replaced by adhesive coating); this step comprises the following steps:

(iiia) soaking the figured-paper mounted poly foam balls into a white glue, then taking them out and placing on a work-bench for drip-drying, the purpose of white glue soaking is to prevent from water stains formation caused by the Epoxy coating penetration underneath the figured-paper in the subsequent process of Epoxy coating soaking;

(iiib) following drip-drying for 2-3 minutes on a work-bench, placing the poly foam balls on a rotary tray to let them evenly rotate for the white glue on the surface of the poly foam balls evenly flowing and distributing, meanwhile, turning on the oven at the region of the rotary tray for oven-drying to prevent the oven-dried poly foam balls from being mildewed due to moisture while re-soaking in the Epoxy coating.

(iv) then soaking the oven-dried semi-finished product into the Epoxy coating, taking them out and oven-drying again, this step comprises the following steps:

(iva) soaking the oven-dried poly foam balls into the Epoxy coating to impart smoothness, transparency, and gloss to the product surface, this step can be replaced by directly pouring the Epoxy coating onto the oven-dried poly foam balls;

(ivb) subsequently, eliminating any air bubbles in the Epoxy coating on the surface of the poly foam ball by heated-air provided by a heated-air gun or in vacuum created by a vacuum pump, checking the surface of the poly foam ball to find any glue-deficient or glue-lost sites, replenishing glue by a brush for the glue-deficient or lost sites, eliminating air bubbles by heated-air or in vacuum to ensure the product surface free of intensive air bubbles so as to effectively enhance the qualified percentage of the product;

(ivc) placing the treated poly foam balls in a rotary tray for even rotation, meanwhile, oven-drying the balls to imparting them a certain hardness, it is the purpose of using a rotary tray is to make the Epoxy coating evenly adhering on the surface of the product.

(v) finally, assembling the glue-soaked and oven-dried poly foam balls according to various requirements to obtain products.

### EXAMPLE 2

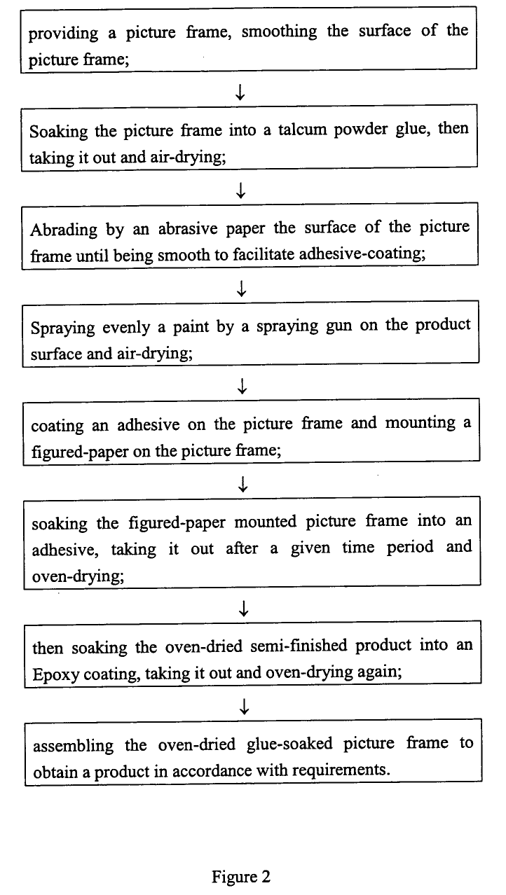

As shown in FIG. 2, in this example a picture frame made of poly foam material is used as a blank to fabricate an oil-sprayed paper-mounted handicraft. The particular technology comprises the following steps:

(i) providing a picture frame, smoothing the surface of the picture frame by surface treatment so as to facilitate the adhesive coating to ensure a smooth surface for the product, wherein the surface treatment of the picture frame comprises the following steps:

(ia) abrading off by an abrasive paper any coarse gripper die lines on the picture frame to make the surface of the picture frame smooth by this first abrasion;

(ib) drilling by a drill a hole in the upper cross member of the picture frame to facilitate the subsequent glue-soaking;

(ic) aiming the hole on the drilled cross member at a fork pin to fix the picture frame on the fork pin;

(id) soaking the picture frame into a talcum powder glue, followed by taking it out and placing it on a work-bench for drip-drying, after being soaked in the talcum powder glue, the surface of the poly foam is covered by a talcum powder layer, which may prevent the poly foam from being destroyed by paint in the oil spraying step;

(ie) brushing away by a brush any excessive glue on the talcum powder glue-soaked picture frame, placing it on a rotary tray for rotation to allow the glue flowing and evenly distributing on the surface for air-drying, the purpose of brushing away the excessive glue is to prevent from the glue-lump formation on the picture frame caused by too massive glue during the picture frame rotating on the rotary tray, on the other hand, the brushed down glue can be recycled and re-used to lower the production cost;

(if) removing the air-dried picture frame, abrading again the surface by an abrasive paper until getting smooth;

(ig) preparing tools and formulating a paint, evenly spraying by a spraying gun the paint onto the product surface to meet various requirements on the oil tint of customers;

(ih) air-drying the oil-sprayed picture frame to avoid the wet paint from being destroyed in the subsequent paper-mounting step.

(ii) coating adhesive on the oil-sprayed picture frame and mounting the figured-paper onto the picture frame; this step comprises the following steps:

(iia) preparing paper-mounting tools and figured-paper, wetting a towel, laying the wet towel on a table, laying flat the figured-paper on the towel, evenly coating by a brush wallpaper adhesive glue on the figured-paper until the figured-paper being entirely wetted by the glue so as to make the figured-paper being more easily pressed without wrinkling;

(iib) evenly coating by a brush the wallpaper powder glue onto the front side of the oil-sprayed picture frame so as to facilitate the figured-paper being adhered on the picture frame;

(iic) mounting the figured-paper on the surface of the picture frame with the mid-line of the figured-paper overlapped on the mid-line of the picture frame and being symmetrical to the upper site and the lower site as well as to the left site and the right site;

(iid) after overlapping the mid-lines, pressing the figured-paper evenly and firmly from center to periphery to permit the figured-paper evenly attached on the picture frame, if the picture frame has fittings, the fittings can be figured paper-mounted in the same way.

(iii) soaking the figured-paper mounted picture frame into an adhesive, taking it out after a given time period and oven-drying; this step comprises the following steps:

(iiia) fixing the fittings by a thermo-molten glue onto the picture frame (if there are no fittings, this step can be omitted), soaking the figured-paper mounted picture frame into the white glue, subsequently taking it out and placing it on a work-bench for drip-drying, the purpose of soaking into the white glue is to prevent from water stains formation caused by the Epoxy coating penetration underneath the figured-paper in the subsequent step of soaking in the Epoxy coating;

(iiib) after drip-drying for 2-3 minutes on a work-bench, placing the picture frame on a rotary tray for rotation at a constant speed to allow the white glue on the surface of the picture frame flowing and evenly distributing, meanwhile, turning on the oven at the rotary tray region for oven-drying, if oven-drying is made when the oven-dried poly foam balls are again soaked in Epoxy coating, the interior of the product will not become mildewed due to moisture;

(iv) then soaking the oven-dried semi-finished product into the Epoxy coating, taking it out and oven-drying again; the detailed procedure of this step comprises:

(iva) soaking the oven-dried picture frame into the Epoxy coating, the purpose of soaking in the Epoxy coating is to impart smoothness, transparency, and gloss to the surface of the product, this step can be replaced by directly pouring the Epoxy coating onto the oven-dried picture frame;

(ivb) then eliminating any air bubbles in the Epoxy coating on the surface of the picture frame by heated-air provided by a heated-air gun or in vacuum created by a vacuum pump, and checking the surface of the picture frame to see if there are any glue-deficient or glue-lost sites, which are to be replenished with the glue by a brush, eliminating any air bubbles by heated-air or in vacuum for ensuring the product surface free of dense air bubbles to effectively enhance the qualified percentage of the product;

(ivc) finally, placing the thus treated picture frame on a rotary tray to rotate at a constant speed and oven-drying in an oven to impart a certain hardness to the product surface, the purpose of using a rotary tray is to make the Epoxy coating evenly attaching on the product surface;

(v) finally assembling the oven-dried picture frame in accordance with requirements to obtain the product.

### EXAMPLE 3

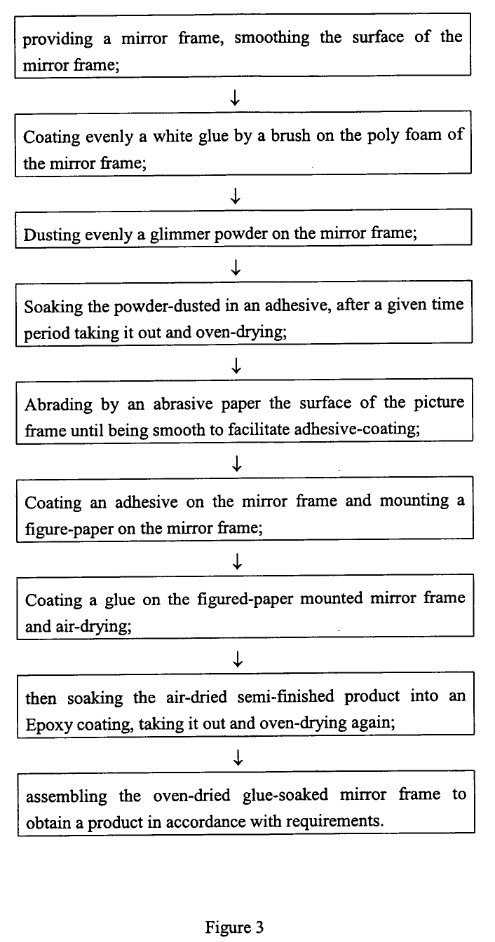

As shown in FIG. 3, this example describes the fabrication of a powder-dusted, paper-mounted handicraft by using a mirror frame made of poly foam material as a blank.

The particular technology comprises the following steps:

(i) providing a mirror frame, smoothing the surface of the mirror frame by surface-treatment until it is ready for glue coating to ensure the final product having a smooth surface, wherein the surface-treatment of the mirror frame comprises the following steps:

(ia) abrading off by an abrasive paper any coarse gripper die lines on the mirror frame to make the surface of the mirror frame smooth;

(ib) drilling by a drill a hole in the upper cross member of the mirror frame to facilitate the subsequent glue-soaking;

(ic) evenly coating by a brush a white glue on the poly foam so as to enable a glimmer powder to adhere on the mirror frame in powder dusting step;

(id) evenly dusting the glimmer powder on the mirror frame, wherein choice of the glimmer powder can by made for different colors in accordance with various requirements to make the surface of the mirror frame more beautiful and more glossy;

(ie) soaking the dusted mirror frame into an Epoxy coating to make the glimmer powder and the Epoxy coating all together adhere on the surface of the mirror surface, this step can also be performed by directly pouring the Epoxy coating onto the mirror frame;

(if) after glue-soaking, coating the Epoxy coating even on the surface of the mirror frame by a brush and checking the surface of the mirror frame to see if there are any glue-deficient or contaminated sites to avoid the glue from unevenness;

(ig) eliminating any air bubbles in the Epoxy coating on the surface of the mirror frame by heated-air provided by a heated-air gun or in vacuum created by a vacuum pump, and checking the surface of the mirror frame to see if there are any glue-deficient or glue-lost sites, which will be replenished with the glue by a brush, eliminating any air bubbles by heated-air or in vacuum for ensuring the product surface free of dense air bubbles to effectively enhance the qualified percentage of the product;

(ih) placing the thus treated mirror frame on a rotary tray to rotate at a constant speed and oven-dried in an oven to impart a certain hardness to the product surface, the purpose of using a rotary tray is to make the Epoxy coating evenly attaching on the product surface;

(ij) abrading by an abrasive paper any coarse sites on the surface of the mirror frame and blowing off any dust produced on the surface of the mirror frame in the abrasion step to facilitate adhesive-coating and figured paper-mounting, ensuring the smoothness of the surface of final product.

(ii) coating adhesive glue on the powder-dusted and surface-treated mirror frame and mounting the figured paper onto the mirror frame, upon operation, this step comprises the following steps:

(iia) preparing figured paper-mounting tools and figured-paper, wetting a towel, laying the wet towel on a table, laying flat the figured-paper on the towel, evenly coating by a brush a wallpaper adhesive glue on the figured-paper until the figured-paper being entirely wetted by the glue so as to make the figured-paper being more easily pressed without wrinkling;

(iib) coating by a brush a wallpaper powder glue onto the front side of the mirror frame so as to facilitate the figured-paper being adhered on the mirror frame;

(iic) mounting the figured-paper on the surface of the mirror frame with the mid-line of the figured-paper overlapped on the mid-line of the mirror frame and being symmetrical to the upper site and the lower site as well as to the left site and the right site;

(iid) after overlapping the mid-lines, pressing the figured-paper evenly and firmly from center to periphery to permit the figured-paper evenly attached on the mirror frame.

(iii) adhesive-coating the figured-paper mounted mirror frame (or soaking it in the adhesive and taking it after a given time period and oven-drying); in operation, this step comprises the following steps:

(iiia) coating a white glue by a brush on the figured-paper and its edges of the figured-paper mounted mirror frame to prevent from water stains formation caused by the Epoxy coating penetration underneath the figured-paper in the subsequent step of soaking in an Epoxy coating;

(iiib) air-drying the glue-coated mirror frame, so that when the air-dried mirror frame is again soaked in the Epoxy coating, the interior of the product will not become mildewed due to moisture;

(iv) then soaking the air-dried semi-finished product into the Epoxy coating, taking it out and oven-drying again, the detailed procedure of this step comprises:

(iva) soaking the paper-mounted and air-dried mirror frame into an Epoxy coating, the purpose of soaking in the Epoxy coating is to impart smoothness, transparency, and gloss to the surface of the product, this step can be replaced by directly pouring the Epoxy coating onto the oven-dried mirror frame;

(ivb) then eliminating any air bubbles in the Epoxy coating on the surface of the mirror frame by heated-air provided by a heated-air gun or in vacuum created by a vacuum pump, and checking the surface of the mirror frame to see if there are any glue-deficient or glue-lost sites, which will be replenished with the glue by a brush, eliminating any air bubbles by heated-air or in vacuum for ensuring the product surface free of dense air bubbles to effectively enhance the qualified percentage of the product;

(ivc), placing the thus treated mirror frame on a rotary tray to rotate at constant speed and oven-dried in an oven to impart a certain hardness to the product surface, the purpose of using a rotary tray is to make the Epoxy coating evenly attaching on the product surface.

(v) finally, assembling the oven-dried mirror frame in accordance with requirements to obtain the product.

Numerous variations and modifications are easily obtainable by means of the skilled person's common knowledge without departing from the scope of the invention. However, such variations and modifications should fall into the scope of this invention.

What is claimed is:

1. A processing technology for paper-mounted handicrafts, comprising the steps of:
(i) providing a blank, smoothing the blank surface by surface-treatment until it is sufficiently smooth for facilitating adhesive-coating;
(ii) coating an adhesive onto the blank and mounting on the blank a figured-paper;
(iii) soaking the figured-paper mounted blank into an adhesive (or coating an adhesive on the blank), after a given time period, taking it out and oven-drying;
(iv) then soaking the oven-dried semi-finished product into an Epoxy coating, taking it out to treat and oven-drying again;
(v) finally, assembling the oven-dried glue-soaked semi-finished product to obtain a product.

2. The processing technology for paper-mounted handicrafts as claimed in claim 1, characterized in that, said step (i) further comprises a step of soaking in a talcum powder, and a step of oil-spraying is arranged between said step (i) and said step (ii).

3. The processing technology for paper-mounted handicrafts as claimed in claim 1, characterized in that, said step (i) further comprises a step of powder-dusting and a step of glue-soaking.

4. The processing technology for paper-mounted handicrafts as claimed in claim 1, characterized in that, said step (i) comprises the steps of:
(ia) cutting off by a knife any protruding or excessive parts on the blank, and keeping the blank in its integrity;
(ib) abrading off by an abrasive paper any coarse gripper die lines;
(ic) polishing the thus abraded blank to make the blank surface smoother and after the polishing, blowing off any dust on the blank surface.

5. The processing technology for paper-mounted handicrafts as claimed in claim 2, characterized in that, said step (i) comprises the steps of:
(ia) cutting off by a knife any protruding or excessive parts on the blank, and keeping the blank in its integrity;
(ib) abrading off by an abrasive paper any coarse gripper die lines;
(ic) polishing the thus abraded blank to make the blank surface smoother and after the polishing, blowing off any dust on the blank surface.

6. The processing technology for paper-mounted handicrafts as claimed in claim 3, characterized in that, said step (i) comprises the steps of:
(ia) cutting off by a knife any protruding or excessive parts on the blank, and keeping the blank in its integrity;
(ib) abrading off by an abrasive paper any coarse gripper die lines;
(ic) polishing the thus abraded blank to make the blank surface smoother and after the polishing, blowing off any dust on the blank surface.

7. The processing technology for paper-mounted handicrafts as claimed in a claim 1, characterized in that, said step (ii) comprises the steps of:
(iia) preparing tools and a figured paper and fixing the polished blank on a work-bench;
(iib) coating by a brush a wallpaper powder glue onto the blank evenly;
(iic) aligning a pattern in the figured paper with the corresponding part of the blank and pressing the figured paper onto the blank to cover the corresponding part of the blank with the figured paper.

8. The processing technology for paper-mounted handicrafts as claimed in a claim 2, characterized in that, said step (ii) comprises the steps of:
(iia) preparing tools and a figured paper and fixing the polished blank on a work-bench;
(iib) coating by a brush a wallpaper powder glue onto the blank evenly;
(iic) aligning a pattern in the figured paper with the corresponding part of the blank and pressing the figured paper onto the blank to cover the corresponding part of the blank with the figured paper.

9. The processing technology for paper-mounted handicrafts as claimed in a claim 3, characterized in that, said step (ii) comprises the steps of:
(iia) preparing tools and a figured paper and fixing the polished blank on a work-bench;
(iib) coating by a brush a wallpaper powder glue onto the blank evenly;
(iic) aligning a pattern in the figured paper with the corresponding part of the blank and pressing the figured paper onto the blank to cover the corresponding part of the blank with the figured paper.

10. The processing technology for paper-mounted handicrafts as claimed in claim 1, characterized in that, said step (iii) comprises the steps of:
(iiia) soaking the figured-paper-mounted blank (a semi-finished product) obtained in step (ii) in a white glue followed by taking it out and placing it on a work-bench to drip-dry the white glue;
(iiib) then placing the white glue drip-dried semi-product on a rotary tray to allow the white glue flowing and evenly distributing, meanwhile, baking the semi-product in an oven.

11. The processing technology for paper-mounted handicrafts as claimed in claim 2, characterized in that, said step (iii) comprises the steps of:
(iiia) soaking the figured-paper-mounted blank (a semi-finished product) obtained in step (ii) in a white glue followed by taking it out and placing it on a work-bench to drip-dry the white glue;
(iiib) then placing the white glue drip-dried semi-product on a rotary tray to allow the white glue flowing and evenly distributing, meanwhile, baking the semi-product in an oven.

12. The processing technology for paper-mounted handicrafts as claimed in claim 3, characterized in that, said step (iii) comprises the steps of:
(iiia) soaking the figured-paper-mounted blank (a semi-finished product) obtained in step (ii) in a white glue followed by taking it out and placing it on a work-bench to drip-dry the white glue;
(iiib) then placing the white glue drip-dried semi-product on a rotary tray to allow the white glue flowing and evenly distributing, meanwhile, baking the semi-product in an oven.

13. The processing technology for paper-mounted handicrafts as claimed in claim 1, characterized in that, said step (iv) comprises the steps of:
(iva) soaking the oven-dried semi-product (or the white glue coated semi-product) into an Epoxy coating to impart smoothness, transparency, and gloss to the product surface;
(ivb) finally, eliminating any air bubbles in the Epoxy coating on the semi-product surface by using heated-air or in vacuum, meanwhile, oven-drying the Epoxy coating in an oven to make the product reaching a certain hardness.

14. The processing technology for paper-mounted handicrafts as claimed in claim 2, characterized in that, said step (iv) comprises the steps of:
(iva) soaking the oven-dried semi-product (or the white glue coated semi-product) into an Epoxy coating to impart smoothness, transparency, and gloss to the product surface;
(ivb) finally, eliminating any air bubbles in the Epoxy coating on the semi-product surface by using heated-air or in vacuum, meanwhile, oven-drying the Epoxy coating in an oven to make the product reaching a certain hardness.

15. The processing technology for paper-mounted handicrafts as claimed in claim 3, characterized in that, said step (iv) comprises the steps of:
(iva) soaking the oven-dried semi-product (or the white glue coated semi-product) into an Epoxy coating to impart smoothness, transparency, and gloss to the product surface;
(ivb) finally, eliminating any air bubbles in the Epoxy coating on the semi-product surface by using heated-air or in vacuum, meanwhile, oven-drying the Epoxy coating in an oven to make the product reaching a certain hardness.

16. The processing technology for paper-mounted handicrafts as claimed in claim 2, characterized in that, said step of soaking in a talcum powder is such a step, wherein the firstly surface-treated blank is soaked in a talcum powder glue, then is taken out and placed on a rotary tray for air-drying, the air-dried blank is ready for second surface treatment.

17. The processing technology for paper-mounted handicrafts as claimed in claim 2, characterized in that, said step of oil-spraying is such a step, wherein the surface-treated blank is subject to oil spraying, that is, by using a spraying gun, an oil is evenly sprayed on the blank, then the oil-sprayed blank is air-dried.

18. The processing technology for paper-mounted handicrafts as clamed in claim 3, characterized in that, said powder-dusting step comprises:
(a) prior to the final surface-treatment, coating a white glue onto the blank;
(b) evenly dusting a glimmer powder onto the white glue-coated blank.

19. The processing technology for paper-mounted handicrafts as claimed in claim 3, characterized in that, said glue-soaking step comprises:
(a) soaking the glimmer powder-dusted blank in an Epoxy coating to allow the Epoxy coating evenly covering the blank surface;
(b) eliminating any air bubbles in the Epoxy coating on the blank surface by heated-air or in vacuum and oven-drying the blank.

20. The processing technology for paper-mounted handicrafts as claimed in claim 3, characterized in that, said glue-coating step is such a step, wherein by using a brush, a white glue is coated on the figured-paper and its edges of the figured-paper mounted blank to prevent from water stains formation caused by Epoxy coating penetration underneath the figured-paper in the subsequent step.
